(19) United States
(12) Patent Application Publication
(10) Pub. No.: US 2025/0040518 A1
(43) Pub. Date: Feb. 6, 2025

(54) HEALTH CONDITION DETERMINATION APPARATUS, HEALTH CONDITION DETERMINATION METHOD, AND PROGRAM

(71) Applicant: NEC Communication Systems, Ltd., Minato-ku, Tokyo (JP)

(72) Inventors: Masakazu KANEDA, Tokyo (JP); Kenichi ABE, Tokyo (JP); Momo SUTO, Tokyo (JP); Chikashi ITO, Tokyo (JP); Tetsuya ITO, Tokyo (JP); Akira MATSUMOTO, Tokyo (JP); Norihiko KAMATA, Tokyo (JP); Satoki UENO, Tokyo (JP)

(73) Assignee: NEC Communication Systems, Ltd., Minato-ku, Tokyo (JP)

(21) Appl. No.: 18/716,535

(22) PCT Filed: Dec. 16, 2022
(86) PCT No.: PCT/JP2022/046371

§ 371 Date: Jun. 5, 2024

(30) Foreign Application Priority Data
Dec. 17, 2021 (JP) 2021-205564

(51) Int. Cl. A01K 29/00

(52) U.S. Cl. CPC A01K 29/005

(57) ABSTRACT

There is provided a health condition determination apparatus including: a behavior data acquisition part that acquires behavior data indicating a behavior of an animal acquired by executing at least one of monitoring and sensing on the animal; a behavior data accumulation part that accumulates the behavior data; and a health condition estimation part that estimates a health condition of the animal by using the behavior data.

### REFERENCE TO RELATED APPLICATION

The present invention is based upon and claims the benefit of the priority of Japanese patent application No. 2021-205564, filed on Dec. 17, 2021, the disclosure of which is incorporated herein in its entirety by reference thereto.

### TECHNICAL FIELD

The present invention relates to a health condition determination apparatus, a health condition determination method, and a program.

### BACKGROUND ART

In recent years, care needs to be taken such that not only humans but also animals such as livestock have a comfortable life. The concept of “animal welfare” is defined as “the physical and mental state of an animal in relation to the conditions in which it lives and dies” by OIE (International Epizootic Office), which is an international organization. Guidelines, etc., about the animal welfare particularly in the field of livestock have been created in various countries.

For example, individual identification is currently performed on beef cattle, and the raising grounds of an individual animal, in addition to the sex and the type, are recorded from birth to slaughtering/death. Thus, it is possible to trace meat by an individual identification number, and food safety and security are ensured. However, from the viewpoint of the animal welfare, the proof that livestock animals have been raised in a healthy physical and mental state is needed, and therefore, information indicating how livestock animals have been raised or whether livestock animals have had a healthy life is additionally needed.

Patent Literature (PTL) 1 discloses the following pastured livestock monitoring system. In this system, the location, the number of steps, the moving speed, etc., of pastured livestock and vital data such as the body temperature, the pulse, the breathing, and the blood pressure are collected by using sensors, and the collected data is stored in a storage area. Based on these behavioral and biological data, AI analyzes the mental state of the pastured livestock.

### CITATION LIST

### Patent Literature

PTL 1: Japanese Unexamined Patent Kokai Publication No. 2019-208470 A

### SUMMARY

### Technical Problem

The disclosure of the above PTL 1 is incorporated herein by reference thereto. The following analysis has been made by the present inventors.

However, a main object of the above disclosed invention is to monitor the current physical and mental state of livestock, and is not directed to comprehensively collecting, analyzing, and accumulating records about the physical and mental health of livestock for their entire life from the viewpoint of the animal welfare.

It is an object of the present invention to provide a health condition determination apparatus, a health condition determination method, and a program that make it possible to prove that animals such as livestock have had a life in a healthy physical and mental state for their entire life and that contribute to providing consumers with guaranteed food safety and security.

### Solution to Problem

According to a first aspect of the present invention or disclosure, there is provided a health condition determination apparatus, including: a behavior data acquisition part that acquires behavior data indicating a behavior of an animal acquired by executing at least any one of monitoring and sensing on the animal; a behavior data accumulation part that accumulates the behavior data; and a health condition estimation part that estimates a health condition of the animal by using the behavior data.

According to a second aspect of the present invention or disclosure, there is provided a health condition determination method, including: a step of acquiring behavior data indicating a behavior of an animal acquired by executing at least any one of monitoring and sensing on the animal; a step of storing the behavior data in a storage area so as to accumulate the behavior data; and a health condition estimation step of estimating a health condition of the animal by using the behavior data.

According to a third aspect of the present invention or disclosure, there is provided a program, causing a computer to execute: processing of acquiring behavior data indicating a behavior of an animal acquired by executing at least one of monitoring and sensing on the animal; processing of storing the behavior data in a storage area so as to accumulate the behavior data; and processing of estimating a health condition of the animal by using the behavior data.

### Advantageous Effects of Invention

According to the individual aspects of the present invention or disclosure, there are provided a health condition determination apparatus, a health condition determination method, and a program that make it possible to prove that animals such as livestock have had a life in a healthy physical and mental state for their entire life and that contribute to providing consumers with guaranteed food safety and security.

### BRIEF DESCRIPTION OF DRAWINGS

FIG. 1 is a block diagram illustrating an example of a configuration of a health condition determination apparatus according to an example embodiment.

FIG. 2 is a block diagram illustrating an example of a configuration of a health condition determination apparatus according to a first example embodiment.

FIG. 3 is a conceptual diagram illustrating an outline of a process of the health condition determination apparatus according to the first example embodiment.

FIG. 4 is a flowchart illustrating an example of an operation of the health condition determination apparatus according to the first example embodiment.

FIG. 5 is a schematic diagram illustrating a hardware configuration of the health condition determination apparatus according to the first example embodiment.

FIG. 6. is a block diagram illustrating an example of a configuration of a health condition determination apparatus according to a second example embodiment.

FIG. 7 is a schematic diagram illustrating an outline of a process of the health condition determination apparatus according to the second example embodiment.

FIG. 8 is a flowchart illustrating an example of an operation of the health condition determination apparatus according to the second example embodiment.

FIG. 9 is a block diagram illustrating an example of a configuration of a health condition determination apparatus according to a third example embodiment.

FIG. 10 is a schematic diagram illustrating an outline of a processing of the health condition determination apparatus according to the third example embodiment.

FIG. 11 is a flowchart illustrating an example of an operation of the health condition determination apparatus according to the third example embodiment.

### EXAMPLE EMBODIMENTS

First, an outline of an example embodiment will be described. In the following outline, various components are denoted by reference characters for the sake of convenience. That is, the following reference characters are used only as examples to facilitate understanding of the present invention. Thus, the description of the outline is not intended to impose any limitations. An individual connection line between blocks in the drawings signifies both one-way and two-way directions. An arrow schematically illustrates a principal signal (data) flow and does not exclude bidirectionality. In addition, while not explicitly illustrated in the circuit diagrams, the block diagrams, the internal configuration diagrams, the connection diagrams, etc., in the disclosure of the present application, an input port and an output port exist at an input end and an output end of an individual connection line. The same holds true for the input/output interfaces.

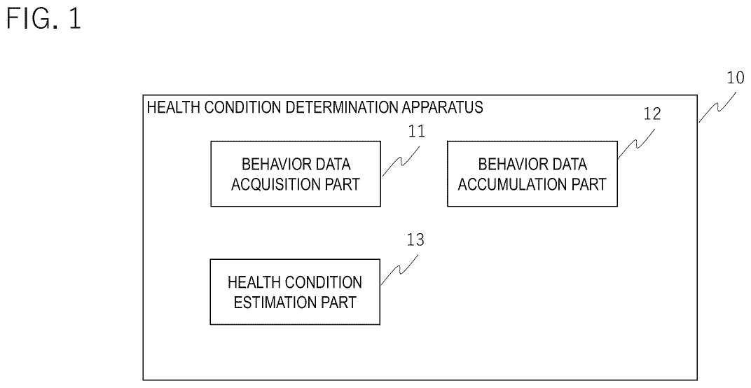

FIG. 1 is a block diagram illustrating an example of a configuration of a health condition determination apparatus according to an example embodiment. As illustrating in FIG. 1, a health condition determination apparatus 10 according to an example embodiment includes a behavior data acquisition part 11, a behavior data accumulation part 12, and a health condition estimation part 13.

The behavior data acquisition part 11 acquires behavior data indicating a behavior of an animal acquired by executing at least any one of monitoring and sensing on the animal. The meaning of this term “animal” includes livestock (dairy cattle, beef cattle, swine, broilers, sheep, horses, etc.). The term “monitoring” refers to monitoring mainly with a camera or the like, and the term “sensing” refers to measuring a particular physical quantity mainly with a sensor. “Monitoring” and/or “sensing” enables identification of an individual animal and tracing of the state of an individual animal. Any devices that are not against the ethics of the animal welfare may be used. For example, any kinds of cameras and sensors may be used in a non-contact or contact manner, and may be adopted in any ways.

The behavior data acquisition part 11 may acquire a “physical motion” expressed by an animal and a “state” such as biological information as the “behavior data”. In addition, the behavior data may be acquired after an individual identification is executed, and may be traceable. The acquired behavior data is sent to the behavior data accumulation part 12 and the health condition estimation part 13, which will be described below.

The behavior data acquisition part 11 may be realized as a separate apparatus geologically away from the location of the health condition determination apparatus. The behavior data acquisition part 11 and the health condition determination apparatus may be connected to each other via a communication network.

The behavior data accumulation part 12 accumulates the behavior data acquired by the behavior data acquisition part 11. This “accumulate” means storing the behavior data that has been acquired from the past up until the present in a storage area. For example, the behavior data accumulation part 12 can accumulate any behavior data such as the location information, the body temperature, and the daily moving distance from the moment of birth to the present. For example, the accumulated behavior data includes not only primary information, which is, for example, the location information simply recorded over time, but also additional information such as secondary information, which is, for example, the moving distance derived from time and location information, or the like, through a calculation process.

The health condition estimation part 13 estimates the health condition of the animal by using the behavior data. The “health condition” refers to an outer (mainly physical) and inner (mainly mental) state of the animal derived from the “behavior data” in accordance with a predetermined procedure or rules. For example, if the behavior data indicates that the animal stays at the same place for a predetermined period of time or more in a particular time period, the health condition estimation part 13 can estimate that the animal is asleep and can estimate the period of time as a sleep duration. In addition, for example, the health condition estimation part 13 can estimate the obesity level from the physique data of the animal such as the body weight and body fat percentage and the food intake included as behavior data. In addition, for example, the health condition estimation part 13 can estimate the health level of the animal by recognizing an injury of the animal with a camera, measuring the body temperature or the like, and comparing these data with a corresponding data history obtained in the past.

Based on the above behavior data or estimated health condition, it is possible to estimate the inner state of the animal, such as the stress level. For example, when the sleep duration and the food intake of a particular individual in the past two days are less than the average, if a particular gesture that is not normally expressed is repeatedly recognized by a camera, the health condition estimation part 13 can estimate that this individual is under stress for some reason. Thus, it is possible to estimate the mental state of the animal such as stress by associating the health condition with the behavior data.

Hereinafter, concrete example embodiments will be described in more detail with reference to the drawings. In the individual example embodiments, the same components will be denoted by the same reference characters, and redundant description thereof will be omitted.

### First Example Embodiment

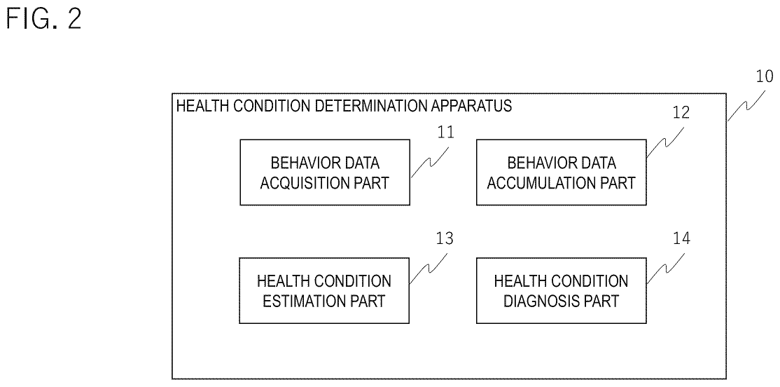

A first example embodiment will be described in detail with reference to the drawings. FIG. 2 is a block diagram illustrating an example of a configuration of a health condition determination apparatus 10 according to a first example embodiment.

The health condition determination apparatus 10 according to the present example embodiment has the following configuration. That is, as illustrated in FIG. 2, the health condition determination apparatus 10 according to the first example embodiment includes a behavior data acquisition part 11, a behavior data accumulation part 12, a health condition estimation part 13, and a health condition diagnosis part 14. The health condition determination apparatus 10 according to the present example embodiment differs from the above-described example embodiment in that this health condition determination apparatus 10 additionally includes the health condition diagnosis part 14.

The health condition diagnosis part 14 diagnoses the health condition of the animal based on the [estimated] health condition. This “diagnosis” refers to evaluating the health condition estimated by the health condition estimation part 13 and providing necessary measures (treatment, medication, etc.) in accordance with a predetermined reference or rules. Concretely, a diagnosis is made by comparing the past data of a particular individual animal or by comparing data of a particular individual animal with data of another individual obtained on the same date.

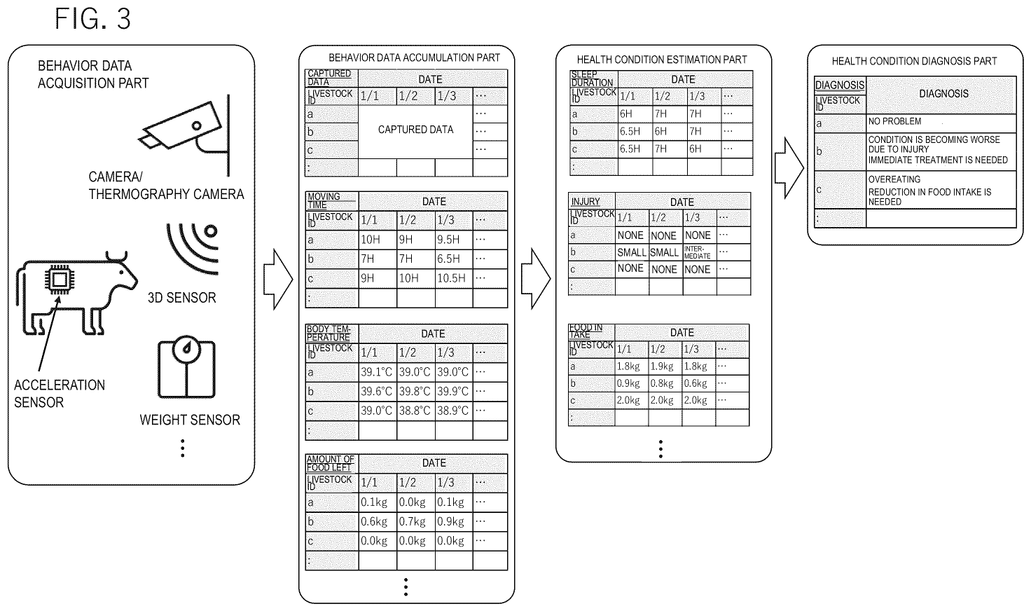

FIG. 3 is a conceptual diagram illustrating an outline of a process of the health condition determination apparatus 10 according to the first example embodiment. As illustrated in FIG. 3, the health condition determination apparatus 10 according to the present example embodiment executes the processes of the behavior data acquisition part 11, the behavior data accumulation part 12, the health condition estimation part 13, and the health condition diagnosis part 14 in this order.

The behavior data acquisition part 11 acquires behavior data by using various kinds of devices. For example, the behavior data acquisition part 11 includes a camera(s) installed at a raising ground(s), a thermography camera(s) that measures the body temperature, a 3D sensor(s) that can recognize a gesture(s) or the like, a weight sensor(s) that measures the body weight, the amount of food left, etc., an acceleration sensor(s) that recognizes movement. An individual may be identified by combining a 3D sensor and a camera.

The acquired behavior data is accumulated in the behavior data accumulation part 12. The behavior data may be accumulated in chronological order per individual and per item. As illustrated in FIG. 3, for example, the data captured by a camera(s), the moving time measured by an acceleration sensor(s) or the like, the body temperature acquired by a thermography camera(s), the amount of food left measured by a weight sensor(s), etc., are accumulated. These data is only an example. Any acquirable data can be accumulated as the behavior data in the behavior data accumulation part 12. These data of animals is accumulated per individual for their entire life from the viewpoint of the animal welfare.

The health condition estimation part 13 executes an estimation (primary analysis) about the health condition of an individual animal by using the behavior data accumulated in the behavior data accumulation part 12. For example, the health condition estimation part 13 executes a process of estimating the sleep duration by using data captured at predetermined timings and moving time, a process of estimating presence or absence of an injury by executing image recognition on captured data, or a process of estimating the intake of food from the amount of food left. In this way, the health condition estimation part 13 calculates and estimates health information from static data by combining data accumulated in the behavior data accumulation part 12. Because this calculation is executed in accordance with predetermined rules, the health condition determination apparatus 10 according to the present example embodiment may include a health condition estimation rule storage part (not illustrated) storing a health condition estimation rule.

As described above, the health condition diagnosis part 14 makes a diagnosis (secondary analysis) by using the estimated health condition. As illustrated in FIG. 3, because a livestock animal “a” has had a stable sleep duration and has no injury, and because the food intake has been within a predetermined range, the health condition diagnosis part 14 diagnoses this livestock animal “a” as being healthy. Because a livestock animal “b” has had an injury, and the size of the injury has been expanding over time from “small” to “intermediate”, the health condition diagnosis part 14 evaluates that the condition of this livestock animal “b” is becoming worse due to the injury. Regarding this evaluation result, necessary measures such as “immediate treatment” are provided as a diagnosis. Likewise, the evaluation result of a livestock animal “c” indicates that the livestock animal “c” tends to eat more than other individuals, and necessary measures such as reduction in food intake are provided.

The above-described sequence from “evaluation” to “proposal” may be executed by using a rule-based artificial intelligence. That is, the health condition determination apparatus 10 may be configured to include a health condition evaluation rule storage part (not illustrated) and a proposal rule storage part (not illustrated). These held rules are declaratively written, and a deduction may be executed by using these rules. For example, a deduction may be executed by using declarative rules in which a knowledge about bovine mastitis is written. The declarative rules indicate “if a fever (increase in body temperature), reduction in appetite (decrease in food intake), reduction in milk production (small decrease in body weight before and after milking), and breast swelling (by image recognition) are observed, it is likely that this animal has bovine mastitis (an evaluation rule)” and “if an animal has bovine mastitis, use of antibiotic is effective (a proposal rule)”. As a result of the execution of the deduction, a process for obtaining a diagnosis indicating that “this animal has bovine mastitis, and antibiotic should be given” may be executed.

In addition, the health condition diagnosis part 14 may calculate a health level index value, which is an index value indicating the health level of the animal, based on the health condition. The index value may be calculated by a predetermined evaluation function. By executing optimization with an evaluation function, a desirable health condition may be calculated and fed back.

### [Description of Operation]

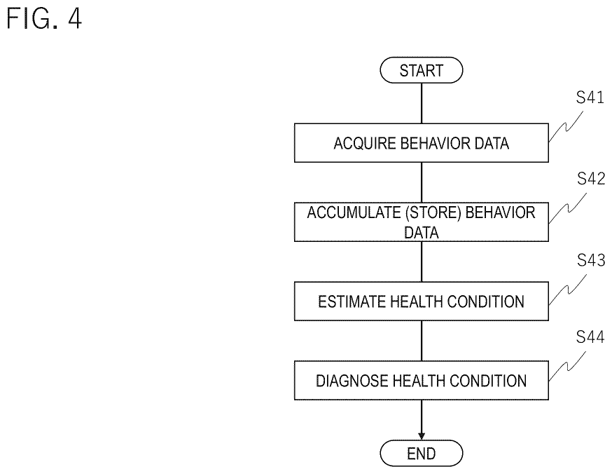

An example of an operation of the health condition determination apparatus 10 according to the present example embodiment will be described with reference to FIG. 4. FIG. 4 is a flowchart illustrating an example of an operation of the health condition determination apparatus 10 according to the first example embodiment.

When starting the operation, the health condition determination apparatus 10 acquires behavior data (step S41). The health condition determination apparatus 10 accumulates (stores) the acquired behavior data (step S42). Next, the health condition determination apparatus 10 estimates a health condition by using the acquired or accumulated behavior data (step S43). Next, the health condition determination apparatus 10 diagnoses a health condition based on the estimated health condition (step S44).

### [Hardware Configuration]

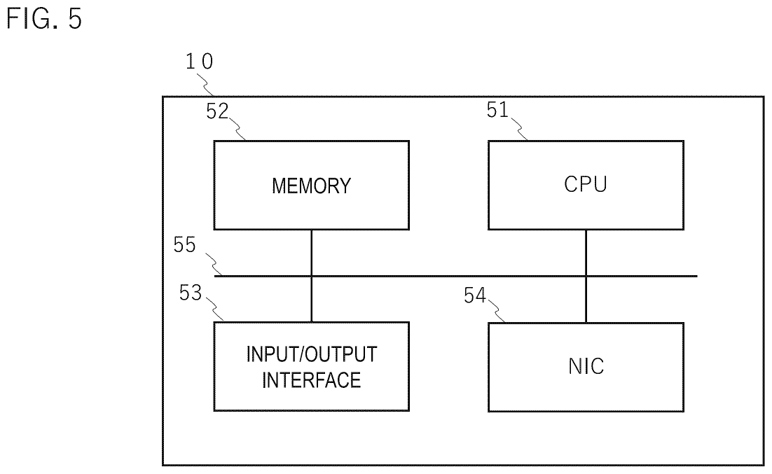

The health condition determination apparatus 10 according to the present example embodiment can be configured by an information processing apparatus (a computer), and includes components illustrated as an example in FIG. 5. For example, the health condition determination apparatus 10 includes a central processing unit (CPU) 51, a memory 52, an input/output interface 53, and a network interface card (NIC) 54, which is communication means. These components are connected to each other via an internal bus 55.

The configuration illustrated in FIG. 5 is not intended to limit the hardware configuration of the health condition determination apparatus 10. The health condition determination apparatus 10 may include hardware not illustrated in FIG. 5 or may be configured without the input/output interface 53, depending on the need. In addition, for example, the number of CPUs included in the health condition determination apparatus 10 is not limited to the example illustrated in FIG. 5. For example, a plurality of CPUs may be included in the health condition determination apparatus 10.

The memory 52 is a random access memory (RAM), a read-only memory (ROM), or an auxiliary storage device (a hard disk, for example).

The input/output interface 53 is means used as an interface for a display device or an input device not illustrated. The display device is, for example, a liquid crystal display. The input device is, for example, a device such as a keyboard or a mouse that receives user operations, or is a device such as a camera, a 3D sensor, or a weight sensor that executes monitoring or sensing.

The functions of the health condition determination apparatus 10 are realized by: a program group (processing modules) such as a behavior data acquisition program, a health condition estimation program, and a health condition diagnosis program; and a data group including accumulated behavior data. For example, the processing modules are realized when the CPU 51 executes their respective programs stored in the memory 52. The individual programs may be updated by downloading program updates via a network or by using a storage medium storing program updates. The processing modules may be realized by semiconductor chips. That is, the health condition determination apparatus 10 has means for executing the functions of the above-described processing modules by using some hardware and/or software.

### [Hardware Operation]

When the health condition determination apparatus 10 starts the operation, the behavior data acquisition program is read out from the memory 52, and becomes executable by the CPU 51. This program acquires images at predetermined timings from a camera(s), which is an input device(s). The program receives an interrupt from an acceleration sensor(s) or the like, which is also an input device(s), and acquires acceleration data or the like. At this point of time, if an individual identification program becomes executable by the CPU 51, the acquired behavior data and an identified individual can be associated with each other.

The behavior data acquisition program stores and accumulates the acquired behavior data in the memory 52. Next, the health condition estimation program is read out from the memory 52 and becomes executable by the CPU 51. This program reads out the accumulated behavior data from the memory 52 and estimates a health condition in combination with one or a plurality of behavior data. In this way, the health condition estimation program generates health condition data, and stores the health condition data in the memory 52.

Next, the health condition diagnosis program is read out from the memory 52, and becomes executable by the CPU 51. This program reads out the health condition data stored in the memory 52, makes a diagnosis (deduction) in accordance with predetermined diagnosis rules, and outputs the diagnosis. The predetermined diagnosis rules may be stored in the memory 52 as diagnosis rule data.

### [Description of Advantageous Effects]

The health condition determination apparatus according to the first example embodiment can acquire and accumulate behavior data of animals and can estimate the health conditions of the animals. In addition, the health condition determination apparatus can make a diagnosis based on a health condition. In this way, the health condition determination apparatus can determine the physical and mental health condition of an individual animal, and can get a knowledge of possible measures (treatment, etc.).

### Second Example Embodiment

In a second example embodiment, a health condition determination apparatus that can extract an individual that exhibits a behavior and a certain (particular) health condition by acquiring behavior data of a plurality of animals that belong to the same herd and by analyzing the behavior data will be described.

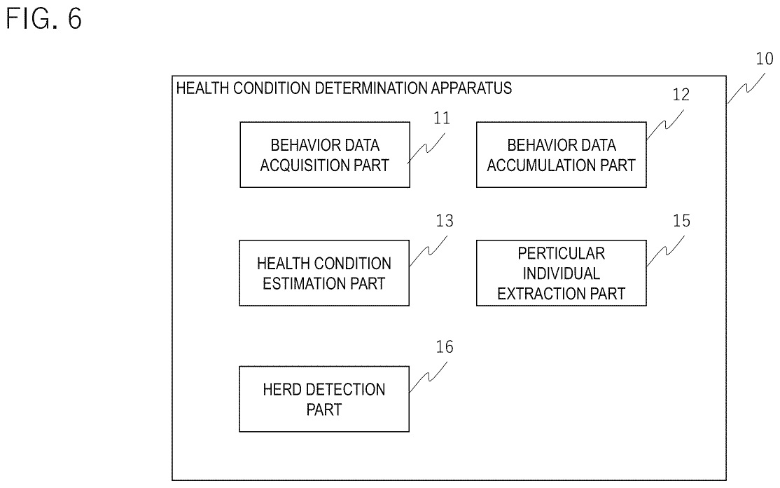

A health condition determination apparatus 10 according to the present example embodiment has the following configuration. That is, as illustrated in FIG. 6, the health condition determination apparatus 10 according to the second example embodiment includes a behavior data acquisition part 11, a behavior data accumulation part 12, a health condition estimation part 13, a herd detection part 16, and a particular individual extraction part 15. The health condition determination apparatus 10 according to the present example embodiment differs from the above first example embodiment in that this health condition determination apparatus 10 additionally includes the herd detection part 16 and the particular individual extraction part 15.

The behavior data acquisition part 11 of the health condition determination apparatus 10 according to the present example embodiment acquires behavior data of a plurality of animals. The behavior data accumulation part 12 accumulates the plurality of behavior data acquired. The health condition estimation part 13 estimates the health conditions of the plurality of animals by using the plurality of behavior data accumulated. The behavior data acquisition part 11 may acquire behavior data of a plurality of animals that belong to the same herd.

The herd detection part 16 detects a herd of animals. The term “herd” refers to a state in which animals cluster. For example, a herd as a unit may refer to all the individuals that are present in a particular livestock barn or a group of animals that are continuously stay or move together after these individual animals naturally cluster. The expression “detect a herd” means determining a plurality of individual animals that belong to a herd. Concretely, for example, the physical range of a herd is first determined by using a camera or a sensor. Next, the individuals located within the determined range are identified. In this way, the individual animals that belong to the herd are determined.

The particular individual extraction part 15 extracts, by using the behavior data of the plurality of animals, an individual animal in a particular state from the plurality of animals. For example, the expression “particular state” refers to a state or the like in which an animal exhibits a behavior that deviates from a herd behavior exhibited by a group such as a herd. To determine this state, for example, the particular individual extraction part 15 first measures the moving speed of the herd, the kinds of gestures, the number of gestures, etc. Next, the particular individual extraction part 15 obtains a statistical distribution of these data, and determines an individual that deviates from the other individuals as being in a particular state. The meaning of this term “deviation” includes not only a state indicating an abnormal behavior due to deterioration in health condition but also a behavior expressed in good health condition.

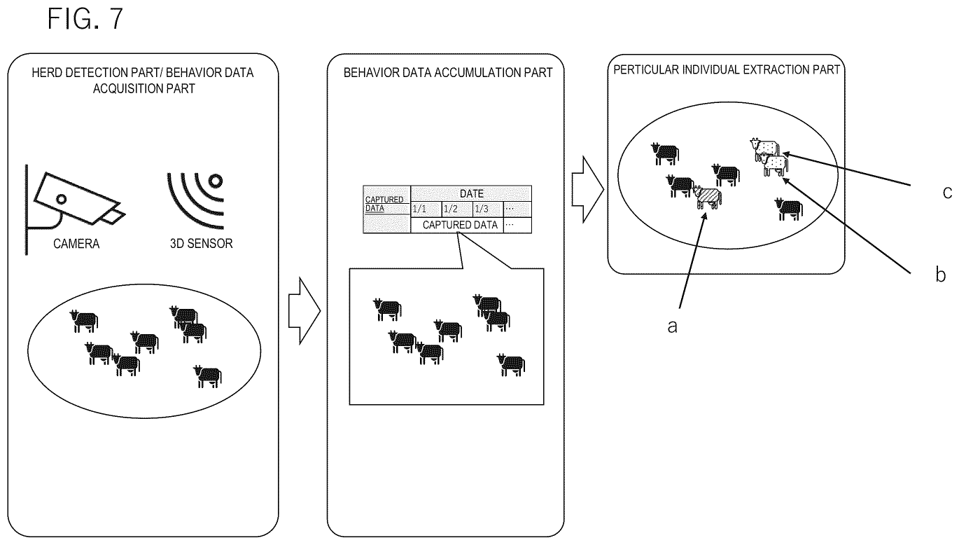

FIG. 7 is a schematic diagram illustrating an outline of a process of the health condition determination apparatus 10 according to the present example embodiment. First, the herd detection part 16 detects a herd. Herein, as an example, a herd is detected by image recognition on an image captured by a camera. While not illustrated, a process of executing individual identification using radio frequency identifiers (RFID) tags or the like may be executed. Next, the behavior data acquisition part 11 acquires behavior data of the plurality of animals that belong to the herd. At this point of time, in addition to the behavior data of each of the plurality of animals (for example, gesture detection by a 3D sensor), the movement of the entire herd (moving speed, etc.) is acquired. Next, the behavior data accumulation part accumulates these acquired data in chronological order.

The particular individual extraction part 15 executes analysis by using the accumulated behavior data, etc., and extracts an individual in a particular state in accordance with predetermined rules. For example, the particular individual extraction part 15 chronologically analyzes the dispersion/density of the individuals in the herd, determines whether there is an isolated individual, and aggregates, for example, the number of contacts with other individuals. Concretely, the particular individual extraction part 15 can measure dispersion/density of the individuals in the herd by recognizing the locations of the individuals through a camera and by detecting locational deviation of each individual in the herd. By combining the measured data with the behavior data of the individuals (the moving speed of the individuals, for example), the particular individual extraction part 15 detects an individual exhibiting a particular behavior. For example, if the density of the individuals around a hatched individual “a” in FIG. 7 is always high, if these individuals consequently come in contact with each other more than the other livestock animals, and if the moving speed of these individuals is greater than the other individuals, it is suspected, from these behavior data, that this hatched individual is exhibiting an abnormal behavior due to stress. As a result, the particular individual extraction part 15 extracts this individual as a particular individual.

On the other hand, although the density of dotted individuals “b” and “c” is high, because these individuals “b” and “c” stay together at the same place for a long time, it is determined that the individuals “b” and “c” are grooming. As a result, the particular individual extraction part 15 extracts the individuals “b” and “c” as physically and mentally healthy individuals. As described above, the health condition determination apparatus 10 according to the present example embodiment can extract not only an individual whose physical and mental health conditions have deteriorated and have become abnormal, that is, an individual as being in a particular state, but also an individual whose health condition is good. Thus, by analyzing, for example, the raising environment of an individual having good health conditions and by feeding back the analysis result to the raising environment of a different individual, it is possible to improve the raising environment of the different individual.

While not illustrated, a particular individual extraction rule storage part that stores extraction rules for the extraction as described above may be included in the health condition determination apparatus 10 according to the present example embodiment. For example, the above individual “a” is extracted based on a rule “if the density of the individuals in the herd has been relatively high for a predetermined time and if the moving speed of the individuals has reached a predetermined speed or greater, the stress level of the livestock is high” and a rule “if the number of contacts with individuals has exceeded a predetermined number within a predetermined time, the density of the individuals is high”. The health condition determination apparatus 10 combines these rules with the behavior data acquired by the behavior data acquisition part 11, such as the frequency at which the individual “a” comes in contact with a different individual in a predetermined time and the moving speed of the individual “a” in a predetermined time, and executes a deduction to determine whether the stress level of the target individual is high and whether the behavior of the individual “a” matches a particular state.

In addition, if the health condition determination apparatus 10 according to the present example embodiment is configured to include the health condition diagnosis part 14, the health condition determination apparatus 10 may execute a diagnosis by associating the diagnosis for an individual obtained by the health condition diagnosis part 14 according to the first example embodiment with the extraction result of a particular individual, which is the same individual as the above individual. For example, if the diagnosis of the health condition of the individual a is good and if the extraction result obtained by the particular individual extraction part 15 indicates an abnormal state, the health condition determination apparatus 10 may output, from the above results, a diagnosis indicating that while this individual is healthy, the individual is in an abnormal state under stress in the herd, and it is necessary to take preventive measures, such as keeping this individual away from the other individuals.

### [Description of Operation]

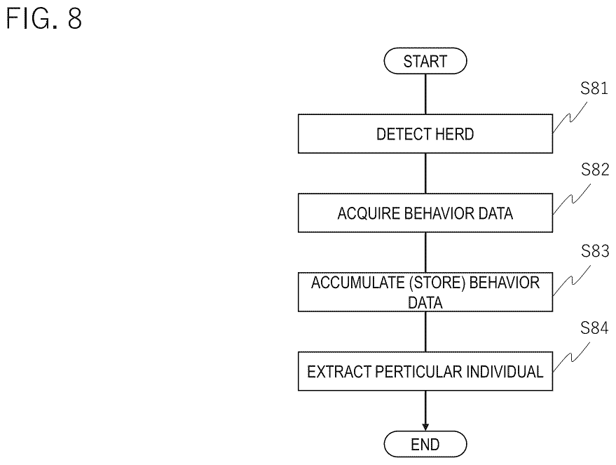

An example of an operation of the health condition determination apparatus 10 according to the present example embodiment will be described with reference to FIG. 8. FIG. 8 is a flowchart illustrating an example of an operation of the health condition determination apparatus 10 according to the second example embodiment. As illustrated in FIG. 8, when starting the process, first, the health condition determination apparatus 10 according to the present example embodiment detects a herd (step S81). Next, the health condition determination apparatus 10 acquires behavior data of the plurality of animals (step S82). The health condition determination apparatus 10 accumulates the acquired behavior data by storing the acquired behavior data in a storage area (step S83). The health condition determination apparatus 10 extracts a particular individual by using the accumulated behavior data (step S84).

### [Hardware Configuration]

The health condition determination apparatus 10 according to the present example embodiment can be configured by an information processing apparatus (a computer), and includes components illustrated as an example in FIG. 5, as is the case with the first example embodiment.

The functions of the health condition determination apparatus 10 according to the present example embodiment are realized by: a program group (processing modules) such as a behavior data acquisition program, a herd detection program, and a particular individual extraction program; and a data group including accumulated behavior data stored in the memory 52.

### [Hardware Operation]

When the health condition determination apparatus 10 starts the operation, the behavior data acquisition program is read out from the memory 52, and becomes executable by the CPU 51. This program acquires images at predetermined timings from a camera(s), which is an input device(s). The acquired image data is stored and accumulated as behavior data in the memory 52. Next, the herd detection program is read out from the memory 52, and becomes executable by the CPU 51. This program recognizes the acquired image data and determines the range of the herd. After determining the range of the herd, individual identification is executed on the herd by using the image data acquired by a 3D sensor(s) or an RFID tag(s).

Next, the particular individual extraction program is read out from the memory 52, and becomes executable by the CPU 51. This program acquires data such as about the location and the movement of the individuals belonging to the same herd from the image data and acceleration sensors attached to the animals, for example. This program analyzes, for example, the acquired location and the movement of the individuals. For example, this program executes a process of outputting an individual whose movement amount is over the movement of the entire herd by a predetermined value or more as an individual in an abnormal state on a display device or the like. A deduction may be executed by combining the output result of the particular individual extraction program with the output result of the health condition diagnosis program of the health condition determination apparatus 10 according to the example embodiment 1, and the deduction result may be outputted as a diagnosis.

### [Description of Advantageous Effects]

The health condition determination apparatus 10 according to the present example embodiment can detect a particular behavior of an individual that belongs to a herd, e.g., can extract an individual in an abnormal state. In this way, the health condition determination apparatus 10 can take measures, e.g., can eliminate the stress factor or the like for the extracted individual in an abnormal state in an early stage. Simultaneously, the health condition determination apparatus 10 can prevent the individuals around the abnormal individual from experiencing the stress. That is, the entire herd can be raised in a healthy state.

### Third Example Embodiment

In a third example embodiment, there is provided a health condition determination apparatus 10. In addition to estimating and diagnosing health conditions based on acquired behavior data, this health condition determination apparatus 10 acquires basic information (animal basic information) including information normally written in medical records such as about the physique (the body weight, the body length, etc.), the age, the sex, and past treatment records (medication records, etc.) of animals. The health condition determination apparatus 10 accumulates the basic information with the behavior data and the health conditions or the diagnoses. In this way, the health condition determination apparatus 10 can extract an individual having basic information similar to that of a selected individual, and can predict the future health condition of the selected individual.

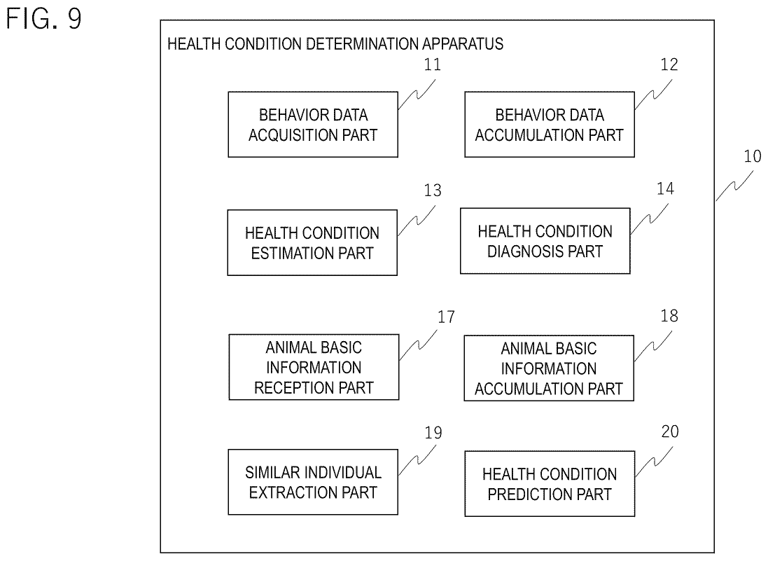

FIG. 9 is a block diagram illustrating an example of a configuration of the health condition determination apparatus 10 according to the third example embodiment. The health condition determination apparatus 10 according to the present example embodiment has the following configuration. That is, as illustrated in FIG. 9, the health condition determination apparatus according to the third example embodiment 10 includes a behavior data acquisition part 11, a behavior data accumulation part 12, a health condition estimation part 13, and a health condition diagnosis part 14. The health condition determination apparatus 10 according to the present example embodiment differs from the above-described example embodiment in that this health condition determination apparatus 10 additionally includes an animal basic information reception part 17, an animal basic information accumulation part 18, a similar individual extraction part 19, and a health condition prediction part 20.

The animal basic information reception part 17 receives animal basic information including at least any one of information about attributes, information about physiques, and information about treatment records of a plurality of animals. The expression “information about attributes” refers to, for example, information about the age, sex, birthplace, etc. The expression “information about physiques” refers to, for example, information about the body length, the body weight, the waist circumference, etc. The expression “information about treatment records” refers to, for example, the past diseases, the corresponding diagnoses, and the details of the treatments (for example, the medication records). The present example embodiment assumes that the “treatment records” also includes records about reception of preventive healthcare such as preventive vaccinations.

The animal basic information is entered such that the animal basic information reception part 17 “receives” the animal basic information. For example, a user may manually enter the animal basic information by using an input device such as a keyboard connected to the input/output interface. Alternatively, for example, by connecting to a database of electronic medical records of a veterinarian and by acquiring data, the animal basic information reception part 17 may automatically receive the animal basic information. The entered information is accumulated in the animal basic information accumulation part 18, which will be described below.

The animal basic information accumulation part 18 accumulates the animal basic information. This “accumulates” refers to storing information including past records in a storage area, and in principle, data is not overwritten and stored. The accumulated animal basic information may be associated with behavior data, health condition data, diagnoses, etc., by data such as animal IDs.

The similar individual extraction part 19 extracts, based on the animal basic information and the health conditions of the animals, a similar individual, which is an individual animal having similar animal basic information. That is, the similar individual extraction part 19 can extract an individual whose animal basic information is similar to that of a different individual animal and who is in a predetermined health condition. For example, the similar individual extraction part 19 can extract an individual whose body length, body weight, and age are similar and whose daily food consumption is over 1.0 kg. Although this extraction process is executed based on the health conditions of the animals, a similar individual may be extracted based on the diagnosis results based on the health conditions. An individual similar to one animal selected from the animals accumulated in the animal basic information accumulation part 18 may be extracted.

Since the animal basic information is constituted by data including past records, a similar individual can be extracted based on the past records and the health conditions. For example, when extracting an individual similar to a 6-month-old individual having a disease, the similar individual extraction part 19 may extract an individual that is currently two years old and had the same disease when this individual was 6 months old.

The health condition prediction part 20 predicts a health condition of the one animal based on the animal basic information and the health condition of the similar individual. For example, an individual in a good health condition may be selected based on the diagnoses, a similar individual may be extracted based on the animal basic information of this individual, and a treatment policy may be determined for a new-born individual not in a good health condition based on the treatment records of the individual in good health condition. In addition, an individual in a poor health condition may be selected based on the diagnoses, and an individual whose transition of the animal basic information or health condition is similar to that of the above individual may be extracted, and an alert may be outputted.

About these predictions, a process of extracting a similar individual for each selected individual or an extraction process using a statistical model may be executed. For example, data of animal basic information or health condition information may be subjected to quantum vectorization, and cluster analysis may be executed on the resultant data, so as to form clusters. Next, the animal basic information of the individuals belonging to the same cluster may be referred to, and a process of predicting the health conditions may be executed, for example. The centroid of the vectors of the individuals, which are the elements forming a cluster, may be calculated, and a group of models, each of which is allocated to a cluster depending on the type, are generated. In this case, for example, the health condition may be predicted or a treatment method may be selected by referring to a model closest to one selected individual.

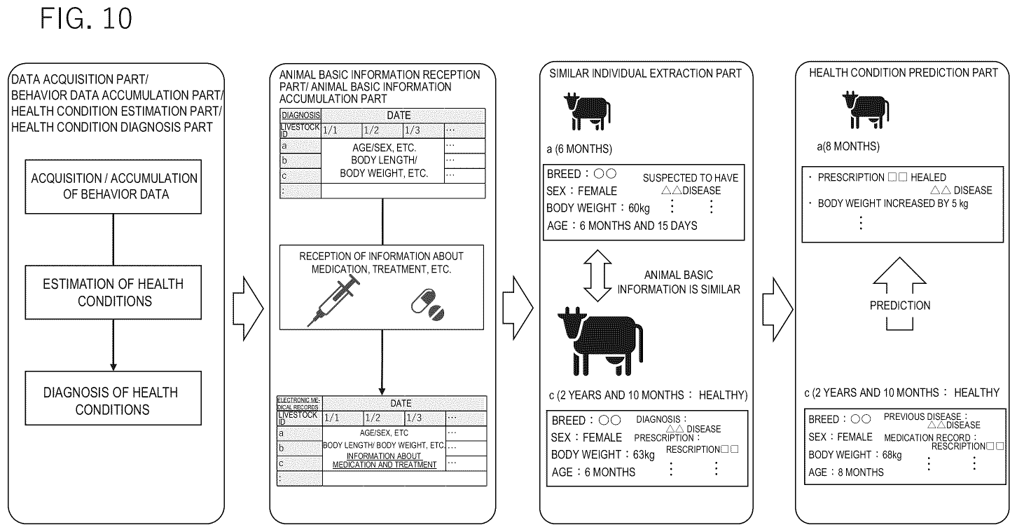

FIG. 10 is a schematic diagram illustrating an outline of a processings of the health condition determination apparatus 10 according to the third example embodiment. As illustrated in FIG. 10, first, a process for acquisition/accumulation of behavior data, estimation of health conditions, and diagnosis of health conditions are executed. Since these processings have already been described in the above example embodiment, description thereof will be omitted. Next, the animal basic information reception part 17 receives input of the information about the attributes such as the age/sex, and the information about the physiques such as the body length/body weight, for example. The received information is accumulated in the animal basic information accumulation part 18. It is desirable that these items of information be regularly entered and accumulated from birth. Every time an animal receives a treatment and medication due to deterioration in health condition, the animal basic information reception part 17 receives input of information about the treatment and medication.

An individual “a” has been selected by the similar individual extraction part 19. This individual “a” is 6 months old, and is suspected to have an XYZ disease as a result of the diagnosis of the health condition. As a result of the similar individual extraction process, an individual “c”, who is healthy and is currently two years and 10 months, has been extracted. The two individuals are the same breed and sex. When the individual “c” was 6 months old, the individual “c” had an XYZ disease, and the body weight then was 63 kg, which is 3 kg heavier than the body weight of the individual “a”. Thus, the individual “a” is similar to the individual “c”. In addition, the individual “c” was given prescription ZZZ. The animal basic information of the individual “c” at 8 months, which was 2 months later, indicates that prescription ZZZ was given to the individual “c”. Because the body weight had increased by 5 kg, it is presumed that the individual “c” had been cured of the XYZ disease and was growing healthfully. From these items of information, it can be predicted that, by giving prescription ZZZ to the individual “a”, the individual “a” will also be cured of the XYZ disease. In addition, it is predicted that the health condition will be recovered, and the body weight will be increased.

### [Description of Operation]

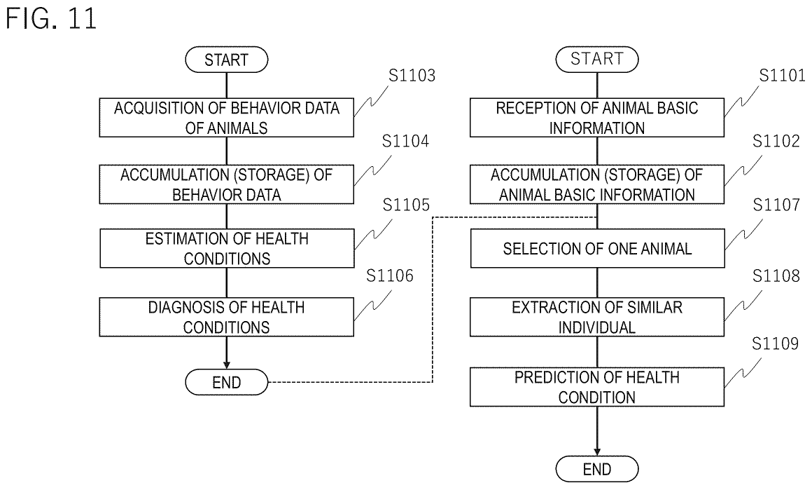

An example of an operation of the health condition determination apparatus 10 according to the present example embodiment will be described with reference to FIG. 11. FIG. 11 is a flowchart illustrating an example of an operation of the health condition determination apparatus 10 according to the third example embodiment. As illustrated in FIG. 11, first, animal basic information is received (step S1101). Next, the received basic information is accumulated (stored in a storage area) (step S1102). After or in parallel with the above sequence, behavior data of a plurality of animals is acquired (step S1103). Next, the acquired behavior data of the plurality of animals is accumulated (stored) (step S1104). Next, health conditions are estimated (step S1105), and the health conditions are diagnosed (step S1106).

Next, one animal whose health condition is to be predicted is selected (step S1107). As illustrated by a dotted line, the sequence from the acquisition of the behavior data of the plurality of animals (step S1103) to the diagnosis of the health conditions (step S1106) is executed and completed in parallel with or before step S1107. Next, a similar individual similar to the selected individual is extracted (step S1108). Finally, a health condition is predicted by using the animal basic information, the behavior data, the health condition, the diagnosis of the health condition, etc., of the similar individual (step S1109).

### [Hardware Configuration]

The health condition determination apparatus 10 according to the present example embodiment can be configured by an information processing apparatus (a computer), and includes components illustrated as an example in FIG. 5, as is the case with the first and second example embodiments.

The functions of the health condition determination apparatus 10 according to the present example embodiment are realized by: a program group (processing modules) such as an animal basic information reception program, a behavior data acquisition program, a health condition estimation program, a health condition diagnosis program, a similar individual extraction program, and a health condition prediction program; and a data group including accumulated behavior data, animal basic information data, etc., stored in the memory 52.

### [Hardware Operation]

When the health condition determination apparatus 10 starts the operation, the animal basic information reception program is read out from the memory 52, and becomes executable by the CPU 51. This program receives animal basic information in data format via a keyboard or the like, which is an input device connected to the input/output interface 53, a network, and the NIC 54, and stores and accumulates the data in the memory 52 as animal basic information data. Next, the behavior data acquisition program, the health condition estimation program, the health condition diagnosis program, etc., are read out from the memory 52 and are operated by the CPU 51 such that the behavior data is stored in the memory 52 and the health conditions, the health condition diagnoses, etc., are outputted. Since the operations by these hardware, etc., have already been described in the above-described example embodiment, redundant description thereof will be omitted.

Next, the similar individual extraction program is read out from the memory 52, and becomes executable by the CPU 51. This program receives selection of one individual through input by, for example, a keyboard connected to the input/output interface 53. Next, the program refers to the animal basic information data of this individual, and extracts an individual whose animal basic information data is similar to that of the selected individual through an arithmetic process. Next, the health condition prediction program is read out from the memory 52, and becomes executable by the CPU 51. This program refers to the accumulated animal basic information data, health condition data, health condition diagnosis data of the extracted similar individual, acquires a health condition such as a disease that could occur in the future, and outputs the health condition as predicted data of the selected individual on a display device or the like.

### [Description of Advantageous Effects]

The health condition determination apparatus 10 according to the present example embodiment can extract an individual similar to one selected individual, and can predict a future health condition of the selected individual from the accumulated animal basic information data, etc., of the extracted individual. In this way, a future risk can be detected from an extracted similar individual whose health condition is not good. On the other hand, from an extracted similar individual whose health condition is good, it is possible to take measures for one selected individual by referring to the treatment, etc., accumulated in the animal basic information data of the extracted similar individual.

The above example embodiments can partially or entirely be described as the following notes. However, the following notes are merely examples of the present invention, and therefore, the present invention is not limited thereto.

### [Note 1]

See the health condition determination apparatus according to the above first aspect.

### [Note 2]

The health condition determination apparatus preferably according to note 1, further including a health condition diagnosis part that diagnoses the health condition of the animal based on the [estimated] health condition.

### [Note 3]

The health condition determination apparatus preferably according to note 2; wherein the health condition diagnosis part calculates a health level index value, which is an index value indicating a health level of the animal, based on the [estimated] health condition.

### [Note 4]

The health condition determination apparatus preferably according to any one of notes 1 to 3;
wherein the behavior data acquisition part acquires behavior data of a plurality of animals;
wherein the behavior data accumulation part accumulates the behavior data of the plurality of animals; and
wherein the health condition estimation part estimates health conditions of the plurality of animals by using the behavior data of the plurality of animals.

### [Note 5]

The health condition determination apparatus preferably according to note 4, further including a herd detection part that detects a herd of animals; wherein the behavior data acquisition part acquires behavior data of a plurality of animals that belong to a same herd.

### [Note 6]

The health condition determination apparatus preferably according to note 4 or 5, further including a particular individual extraction part that extracts, by using the behavior data of the plurality of animals, an individual animal in a particular state from among the plurality of animals.

### [Note 7]

The health condition determination apparatus preferably according to any one of notes 4 to 6, further including:
an animal basic information reception part that receives animal basic information including at least any one of information about attributes, information about physiques, and information about treatment records of a plurality of animals;
an animal basic information accumulation part that accumulates the animal basic information; and
a similar individual extraction part that extracts, based on the animal basic information and the health conditions of the animals, a similar individual, who is an individual animal having similar animal basic information.

### [Note 8]

The health condition determination apparatus preferably according to note 7;
wherein the similar individual extraction part extracts a similar individual similar to one animal selected from the plurality of animals; and
wherein the health condition determination apparatus further includes a health condition prediction part that predicts a health condition of the one animal based on the animal basic information and the health condition of the similar individual.

### [Note 9]

See the health condition determination method according to the above second aspect.

### [Note 10]

See the program according to the above third aspect.

Notes 9 and 10 can be expanded in the same way as note 1 is expanded into notes 2 to 8.

The disclosure of the above PTL, etc., referred to in the above is incorporated herein by reference thereto. Modifications and adjustments of the example embodiments or examples are possible within the scope of the overall disclosure (including the claims) of the present invention and based on the basic technical concept of the present invention. Various combinations or selections (including partial deletion) of various disclosed elements (including the elements in each of the claims, example embodiments, examples, and drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been concretely disclosed.

### REFERENCE SIGNS LIST

10 health condition determination apparatus
11 behavior data acquisition part
12 behavior data accumulation part
13 health condition estimation part
14 health condition diagnosis part
15 particular individual extraction part
16 herd detection part
17 animal basic information reception part
18 animal basic information accumulation part
19 similar individual extraction part
20 health condition prediction part
51 CPU
52 memory
53 input/output interface
54 NIC
55 internal bus

What is claimed is:

1. A health condition determination apparatus, comprising:
a behavior data acquisition part that acquires behavior data indicating a behavior of an animal acquired by executing at least any one of monitoring and sensing on the animal;
a behavior data accumulation part that accumulates the behavior data; and
a health condition estimation part that estimates a health condition of the animal by using the behavior data.

2. The health condition determination apparatus according to claim 1, further comprising a health condition diagnosis part that diagnoses the health condition of the animal based on the estimated health condition.

3. The health condition determination apparatus according to claim 2; wherein the health condition diagnosis part calculates a health level index value, which is an index value indicating a health level of the animal, based on the estimated health condition.

4. The health condition determination apparatus according to claim 1;
wherein the behavior data acquisition part acquires behavior data of a plurality of animals;
wherein the behavior data accumulation part accumulates the behavior data of the plurality of animals; and
wherein the health condition estimation part estimates health conditions of the plurality of animals by using the behavior data of the plurality of animals.

5. The health condition determination apparatus according to claim 4, further comprising a herd detection part that detects a herd of animals; wherein the behavior data acquisition part acquires behavior data of a plurality of animals that belong to a same herd.

6. The health condition determination apparatus according to claim 4, further comprising a particular individual extraction part that extracts, by using the behavior data of the plurality of animals, an individual animal in a particular state from among the plurality of animals.

7. The health condition determination apparatus according to claim 4, further comprising:
an animal basic information reception part that receives animal basic information including at least any one of information about attributes, information about physiques, and information about treatment records of a plurality of animals;
an animal basic information accumulation part that accumulates the animal basic information; and
a similar individual extraction part that extracts, based on the animal basic information and the health conditions of the animals, a similar individual, who is an individual animal having similar animal basic information.

8. The health condition determination apparatus according to claim 7;
wherein the similar individual extraction part extracts a similar individual similar to one animal selected from the plurality of animals; and
wherein the health condition determination apparatus further comprises a health condition prediction part that predicts a health condition of the one animal based on the animal basic information and the health condition of the similar individual.

9. A health condition determination method, comprising:
acquiring behavior data indicating a behavior of an animal acquired by executing at least any one of monitoring and sensing on the animal;
storing the behavior data in a storage area so as to accumulate the behavior data; and
estimating a health condition of the animal by using the behavior data.

10. A non-transitory computer readable recording medium storing a program, causing a computer to execute:
processing of acquiring behavior data indicating a behavior of an animal acquired by executing at least any one of monitoring and sensing on the animal;
processing of storing the behavior data in a storage area so as to accumulate the behavior data; and
processing of estimating a health condition of the animal by using the behavior data.

11. The health condition determination apparatus according to claim 2;
wherein the behavior data acquisition part acquires behavior data of a plurality of animals;
wherein the behavior data accumulation part accumulates the behavior data of the plurality of animals; and
wherein the health condition estimation part estimates health conditions of the plurality of animals by using the behavior data of the plurality of animals.

12. The health condition determination apparatus according to claim 3;
wherein the behavior data acquisition part acquires behavior data of a plurality of animals;
wherein the behavior data accumulation part accumulates the behavior data of the plurality of animals; and
wherein the health condition estimation part estimates health conditions of the plurality of animals by using the behavior data of the plurality of animals.

13. The health condition determination apparatus according to claim 11, further comprising a herd detection part that detects a herd of animals; wherein the behavior data acquisition part acquires behavior data of a plurality of animals that belong to a same herd.

14. The health condition determination apparatus according to claim 12, further comprising a herd detection part that detects a herd of animals; wherein the behavior data acquisition part acquires behavior data of a plurality of animals that belong to a same herd.

15. The health condition determination apparatus according to claim 11, further comprising a particular individual extraction part that extracts, by using the behavior data of the plurality of animals, an individual animal in a particular state from among the plurality of animals.

16. The health condition determination apparatus according to claim 12, further comprising a particular individual extraction part that extracts, by using the behavior data of the plurality of animals, an individual animal in a particular state from among the plurality of animals.

17. The health condition determination apparatus according to claim 13, further comprising a particular individual extraction part that extracts, by using the behavior data of the plurality of animals, an individual animal in a particular state from among the plurality of animals.

18. The health condition determination apparatus according to claim 14, further comprising a particular individual extraction part that extracts, by using the behavior data of the plurality of animals, an individual animal in a particular state from among the plurality of animals.

19. The health condition determination apparatus according to claim 11, further comprising:
an animal basic information reception part that receives animal basic information including at least any one of information about attributes, information about physiques, and information about treatment records of a plurality of animals;
an animal basic information accumulation part that accumulates the animal basic information; and
a similar individual extraction part that extracts, based on the animal basic information and the health conditions of the animals, a similar individual, who is an individual animal having similar animal basic information.

20. The health condition determination apparatus according to claim 12, further comprising:
an animal basic information reception part that receives animal basic information including at least any one of information about attributes, information about physiques, and information about treatment records of a plurality of animals;
an animal basic information accumulation part that accumulates the animal basic information; and
a similar individual extraction part that extracts, based on the animal basic information and the health conditions of the animals, a similar individual, who is an individual animal having similar animal basic information.
